(19) United States
(12) Patent Application Publication
(10) Pub. No.: US 2021/0073747 A1
(43) Pub. Date: Mar. 11, 2021

(54) REUSE MATERIAL MANAGEMENT APPARATUS, REUSE MATERIAL MANAGEMENT SYSTEM, AND REUSE MATERIAL MANAGEMENT METHOD

(71) Applicant: TOSHIBA TEC KABUSHIKI KAISHA, Tokyo (JP)

(72) Inventor: Takahide KUBOTA, Mishima Shizuoka (JP)

(21) Appl. No.: 16/923,968

(22) Filed: Jul. 8, 2020

(30) Foreign Application Priority Data
Sep. 10, 2019 (JP) 2019-164704

(51) Int. Cl. G06Q 10/00; G06Q 10/08

(52) U.S. Cl. CPC G06Q 10/30; H04W 88/02; G06Q 10/0833; G06Q 10/08355

(57) ABSTRACT

In accordance with an embodiment, a reuse material management apparatus includes a communication device, a storage device, and a processor. The processor obtains event information including detection position information indicating a position of the reuse material from the communication terminal apparatus via the communication device. The processor determines, on the basis of allowable position information included in an allowable route information stored in the storage device and detection position information of the reuse material included in the obtained event information route violation of a state of being deviated from the allowable route of the reuse material.

### CROSS-REFERENCE TO RELATED APPLICATION

This application is based upon and claims the benefit of priority from the prior Japanese Patent Application No. 2019-164704, filed on Sep. 10, 2019, the entire contents of which are incorporated herein by reference.

### FIELD

An embodiment described here generally relates to a reuse material management apparatus, a reuse material management system, and a reuse material management method.

### BACKGROUND

Logistics companies transport goods using distribution vehicles such as pallets, returnable boxes, containers, and carts. The distribution vehicles are called reuse materials or the like because they are used repeatedly.

Moreover, logistics company operators assign identification information (hereinafter, referred to as “material identification information”) to such reuse materials. When the goods arrive or are shipped with the reuse materials, the logistics company operators read the material identification information through readers to thereby manage the arriving or shipped goods.

The reuse materials owned by the logistics companies are precious resources, and there is a demand for more efficient use. For example, the conveyance goods vary depending on routes and the type of reuse material varies depending on the conveyance goods. In other words, the reuse material (type) is determined for each route. However, a type of reuse material that is not originally used may also be used in a predetermined route.

Moreover, the reuse materials owned by the logistics companies are used in a logistics center that operators of many logistics companies enter and exit. Each logistics company undertakes goods transportation in a predetermined route and transport the goods by using the owned reuse materials. Under these circumstances, reuse materials which are not originally used in the predetermined route may be used.

Such use of reuse materials other than for the original purpose may cause lowering of the use efficiency of reuse materials, stagnation of reuse materials, or loss of reuse materials. There are requests from logistics companies to grasp the use of reuse materials other than for the original purpose and to cope with the use of reuse materials other than for the original purpose. However, it is a heavy burden on a person in charge for grasping the use of reuse materials other than for the original purpose, and it is thus desirable to provide a technology of managing the use status of reuse materials without the heavy burden on the person in charge.

### BRIEF DESCRIPTION OF THE DRAWINGS

FIG. 1 is a diagram schematically showing an example of a reuse material management system according to an embodiment.

FIG. 2 is a diagram showing an example of a reuse material management apparatus according to the embodiment.

FIG. 3 is a diagram showing an example of a communication terminal apparatus according to the embodiment.

FIG. 4 is a diagram showing an example of an event information table managed by the reuse material management apparatus according to the embodiment.

FIG. 5 is a diagram showing an example of a reuse material management information table managed by the reuse material management apparatus according to the embodiment.

FIG. 6 is a diagram showing an example of a route information table managed by the reuse material management apparatus according to the embodiment.

FIG. 7 is a diagram showing an example of a stagnation information table managed by the reuse material management apparatus according to the embodiment.

FIG. 8 is a flow chart showing an example of arrival/shipment processing by the communication terminal apparatus according to the embodiment.

FIG. 9 is a flowchart showing an example of a determination as to the use of a reuse material other than for the original purpose by the reuse material management apparatus according to the embodiment.

FIG. 10 is a flowchart showing an example of stagnation control of a reuse material by the reuse material management apparatus according to the embodiment.

### DETAILED DESCRIPTION

In accordance with one embodiment, a reuse material management apparatus receives information about a reuse material that is moved with goods loaded or accommodated in the reuse material, from a communication terminal apparatus, and manages a reuse material. The reuse material management apparatus includes a communication device, a storage device, and a processor. The communication device communicates with the communication terminal apparatus. The storage device stores allowable route information of the reuse material. The allowable route information includes allowable position information indicating an allowable position included in an allowable route for movement set with respect to the reuse material. The processor obtains event information including detection position information indicating a position of the reuse material from the communication terminal apparatus via the communication device. The processor determines, on the basis of the allowable position information included in the allowable route information and detection position information of the reuse material included in the obtained event information, route violation of a state of deviated from the allowable route of the reuse material. In addition, the processor outputs a determination result of the route violation of the reuse material via the communication device.

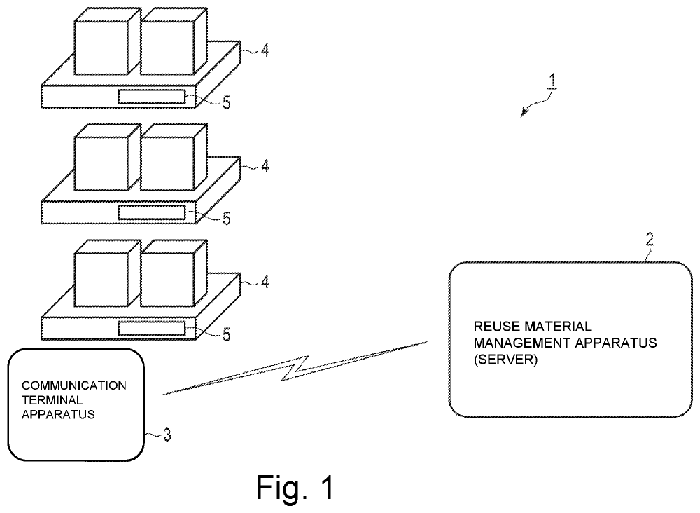

Hereinafter, an embodiment will be described in detail with reference to the drawings. The same reference signs in the drawings will denote the same or similar portions. FIG. 1 shows an example of a reuse material management system 1 according to the embodiment. As shown in FIG. 1, the reuse material management system 1 includes a reuse material management apparatus 2, and a plurality of communication terminal apparatuses 3. The reuse material management apparatus 2 includes one or more general-purpose computers and the like. The reuse material management apparatus 2 is, for example, a server and communicates directly or indirectly with the communication terminal apparatus 3 via a network and receives information from the communication terminal apparatus 3.

The communication terminal apparatus 3 includes a mobile communication terminal apparatus and the like. The communication terminal apparatus 3 reads material identification information or the like stored in an information storage medium 5 assigned to each reuse material 4. Then, the communication terminal apparatus 3 sends event information including the read the material identification information and the like to the reuse material management apparatus 2. For example, the information storage medium 5 is a radio frequency identification (RFID) tag or the like. Alternatively, recording information of a code symbol such as a two-dimensional data code may be employed instead of the information storage medium 5.

The reuse materials 4 include pallets, returnable boxes, containers, and carts. The reuse material 4 is transported in a state in which goods are loaded or accommodated. Many goods are accommodated in a plurality of reuse materials 4 and transported from a desired arrival destination to a desired shipment destination. Moreover, the information storage medium 5 in which unique material identification information is stored is attached to each of the plurality of reuse materials 4. For example, a person in charge carries the communication terminal apparatus 3 and brings the communication terminal apparatus 3 closer to the information storage medium 5 attached to the reuse material 4 when the goods loaded or accommodated in the reuse material 4 is loaded or shipped. When the communication terminal apparatus 3 is brought close to the information storage medium 5, it reads the material identification information stored in the information storage medium 5.

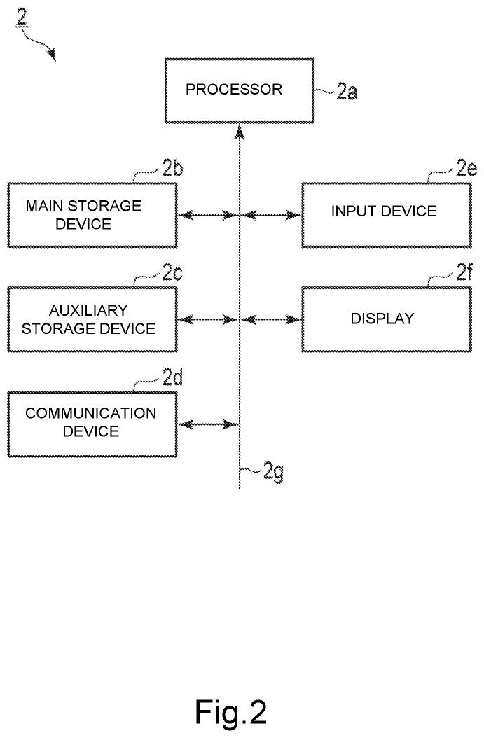

FIG. 2 shows an example of the reuse material management apparatus 2 according to the embodiment. As shown in FIG. 2, the reuse material management apparatus 2 includes a processor 2a, a main storage device 2b, an auxiliary storage device 2c, a communication device 2d, an input device 2e, a display 2f, and a system transmission line 2g. The system transmission line 2g includes an address bus, a data bus, a control signal line, and the like. The system transmission line 2g connects the processor 2a, the main storage device 2b, the auxiliary storage device 2c, the communication device 2d, the input device 2e, and the display 2f to one another.

The processor 2a corresponds to a central part of the reuse material management apparatus 2 and is an information processing unit that performs operations and the like on the basis of various types of information. The processor 2a controls the respective blocks to realize various functions as the reuse material management apparatus 2 in accordance with an operating system and application programs. The processor 2a is, for example, a central processing unit (CPU).

The main storage device 2b includes a non-volatile storage area and a volatile storage area. The non-volatile storage area is, for example, a read only memory (ROM). The volatile storage area is, for example, a random access memory (RAM). The non-volatile storage area stores some or all of the operating system and application programs. The volatile storage area temporarily stores arithmetic operation data and the like of the processor 2a.

The auxiliary storage device 2c includes a non-volatile storage area. The auxiliary storage device 2c includes, for example, one or more of an electric erasable programmable read-only memory (EEPROM), a hard disk drive (HDD), a solid state drive (SSD), and the like. The auxiliary storage device 2c stores some or all of the operating system and application programs. Moreover, the auxiliary storage device 2c stores data used by the processor 2a to perform operations and the like, data generated by processing of the processor 2a, and the like. For example, the auxiliary storage device 2c stores an event information table 231 including event information, a reuse material management information table 232 including reuse material management information, a route information table 233 including allowable route information, and a stagnation information table 234 including stagnation information. These tables will be described later in detail.

The application programs stored in at least one of the main storage device 2b and the auxiliary storage device 2c include a control program (including a reuse material management program) written with respect to the processing executed in the reuse material management apparatus 2. A method of installing the control program in the auxiliary storage device 2c is not particularly limited. The control program may be recorded on a removable storage medium or the control program may be distributed over a network and installed on the auxiliary storage device 2c. The storage medium may be any form of non-temporary computer-readable storage medium capable of storing programs, such as CD-ROMs, memory cards, and the like, and readable by the apparatus.

The communication device 2d communicates data with the communication terminal apparatus 3 over the network. The communication device 2d functions as an obtaining unit for obtaining information from the communication terminal apparatus 3 and an outputting unit for outputting various types of information to the communication terminal apparatus 3. Moreover, the communication device 2d also functions as a notification unit that directly or indirectly notifies a general-purpose computer of various types of information through a network.

The input device 2e receives entries of various types of information from an operator. The display 2f is a display unit for displaying various types of information. The display 2f functions as an outputting unit for outputting various types of information such as route violation. The route violation will be described later in detail.

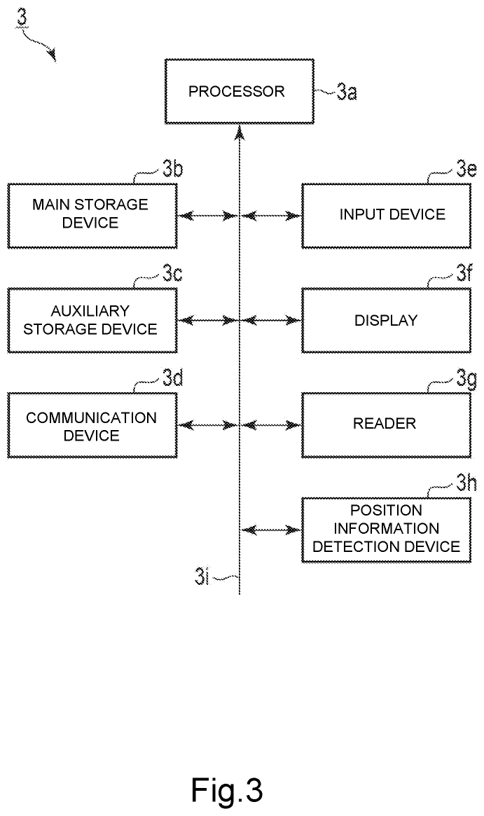

FIG. 3 shows an example of the communication terminal apparatus 3 according to the embodiment. As shown in FIG. 3, the communication terminal apparatus 3 includes a processor 3a, a main storage device 3b, an auxiliary storage device 3c, a communication device 3d, an input device 3e, a display 3f, a reader 3g, a position information detection device 3h, and a system transmission line 3i. The system transmission line 3i includes an address bus, a data bus, a control signal line, and the like. The system transmission line 3i connects the processor 3a, the main storage device 3b, the auxiliary storage device 3c, the communication device 3d, the input device 3e, the display 3f, the reader 3g, and the position information detection device 3h to one another.

The processor 3a corresponds to a central part of the communication terminal apparatus 3 and functions as an information processing unit that performs operations and the like on the basis of various types of information. The processor 3a controls the respective blocks to realize various functions as the communication terminal apparatus 3 in accordance with an operating system and application programs. The processor 3a is, for example, a CPU.

The main storage device 3b includes a non-volatile storage area and a volatile storage area. The non-volatile storage area is, for example, a ROM. The volatile storage area is, for example, a RAM. The non-volatile storage area stores some or all of the operating system and application programs. The volatile storage area temporarily stores arithmetic operation data and the like of processor 3a.

The auxiliary storage device 3c includes a non-volatile storage area. The auxiliary storage device 3c includes one or more of, for example, an EEPROM, an HDD, an SSD, and the like. The auxiliary storage device 3c stores some or all of the operating system and application programs. Moreover, the auxiliary storage device 3c stores data used by the processor 3a to perform operations, data generated by processing of processor 3a, and the like.

For example, the auxiliary storage device 3c stores material identification information read from an RFID tag. Moreover, the auxiliary storage device 3c stores date and time information about date and time when the material identification information is read, position information about a position where the material identification information is read, and an arrival status or a shipment status set as event identification information. The event identification information indicates the type of event of the reuse material 4. The event includes statuses of arrival, shipment, and the like of goods loaded or accommodated in the reuse material 4.

The application programs stored in at least one of the main storage device 3b and the auxiliary storage device 3c include a control program written with respect to the information processing executed in the communication terminal apparatus 3. A method of installing the control program in the auxiliary storage device 3c is not particularly limited.

The control program may be recorded on a removable storage medium or the control program may be distributed over a network and installed on the auxiliary storage device 3c. The storage medium may be any form of non-temporary computer-readable storage medium capable of storing programs, such as CD-ROMs, memory cards, and the like, and readable by the apparatus.

The communication device 3d is a communication unit that performs data communication with the reuse material management apparatus 2 connected via a network. For example, the communication device 3d communicates with the reuse material management apparatus 2 and receives current date and time information provided from the reuse material management apparatus 2.

The input device 3e receives entries of various types of information from an operator. For example, the input device 3e receives an entry for setting the arrival/shipment status as the event identification information. The input device 3e is operated by the person in charge at the time of arrival of goods accumulated or accommodated in the reuse material 4, and receives an entry of the arrival status indicating the time of arrival of goods. The arrival status is set as the event identification information by being stored in the auxiliary storage device 3c. Moreover, the input device 3e is operated by the person in charge at the time of shipment of goods accumulated or accommodated in the reuse material 4 and receives an entry of the shipment status indicating the time of shipment of the goods. The shipment status is stored in the auxiliary storage device 3c and is set as the event identification information. The roles of the arrival status and the shipment status will be described later in detail.

The display 3f displays various types of information for an operator. For example, the display 3f displays a determination result of route violation or the like sent from the reuse material management apparatus 2. The display 3f also displays stagnation detection result sent from the reuse material management apparatus 2. The determination result of the route violation or the like and the stagnation detection result will be described later in detail.

The reader 3g reads the material identification information stored in the information storage medium 5 attached to the reuse material 4. In a case where an RFID tag is used as the information storage medium 5, the reader 3g is an RFID reader with an antenna. Then, when the communication terminal apparatus 3 is moved close to the RFID tag, the reader 3g of the communication terminal apparatus 3 reads the material identification information stored in the RFID tag by radio communication. When a code symbol such as a two-dimensional data code is used instead of the information storage medium 5, the reader 3g is a two-dimensional data code reader with an imaging device. Then, when an image of the code symbol is captured by the imaging device, the reader 3g reads the two-dimensional data code from the image captured by the imaging device. The position information detection device 3h detects a current position using a global positioning system (GPS) or the like.

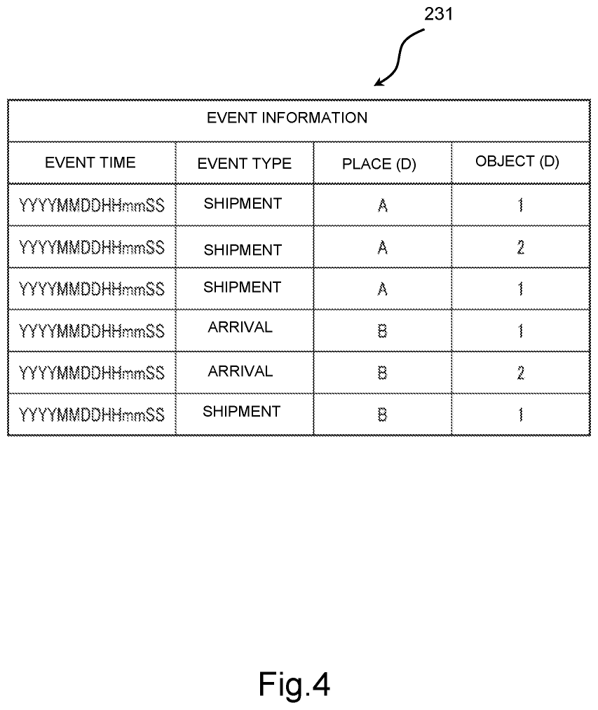

Next, tables managed by the reuse material management apparatus 2 will be described. FIG. 4 shows an example of the event information table 231 managed by the reuse material management apparatus 2 according to the embodiment. For example, the auxiliary storage device 2c of the reuse material management apparatus 2 stores the event information table 231. As shown in FIG. 4, the event information table 231 includes a plurality of records each including event information. The event information includes date and time information (Event Time) indicating date and time of occurrence of an event such as arrival or shipment, event type information (Event Type) indicating the type of event such as arrival or shipment, detection position information (Place (D)) indicating a position detected at the time of occurrence of the event such as arrival or shipment, material identification information (Object ID) stored in the information storage medium 5, and the like. It should be noted that the detection position information corresponds to actual position information of the reuse material 4 and includes GPS coordinates that indicate latitude and longitude.

The material identification information corresponds to material identification information inherent in the reuse material 4. Based on the event information table 231, the processor 2a detects a use status and the like of the reuse material 4.

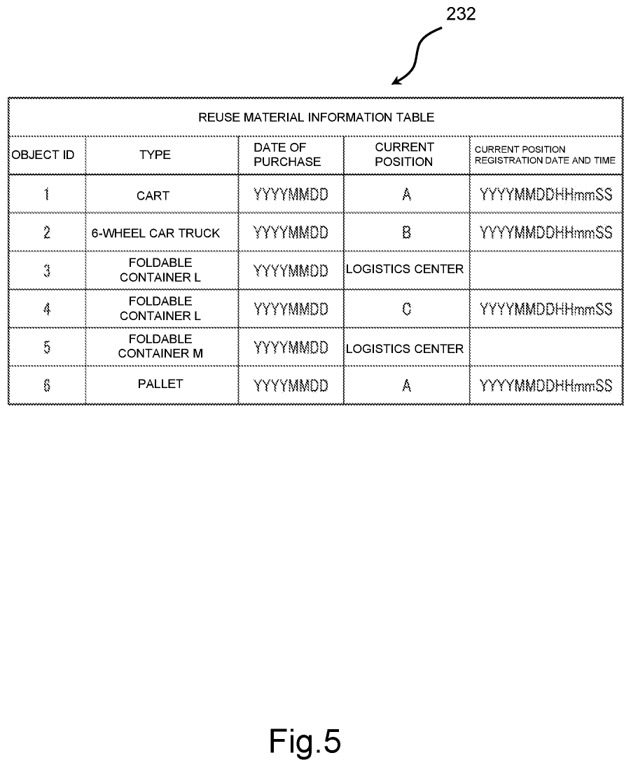

FIG. 5 shows an example of the reuse material management information table 232 managed by the reuse material management apparatus 2 according to the embodiment.

For example, the auxiliary storage device 2c of the reuse material management apparatus 2 stores the reuse material management information table 232. As shown in FIG. 5, the reuse material management information table 232 includes a plurality of records each including reuse material management information. The reuse material management information includes material identification information (Object ID) stored in the information storage medium 5, material type information (Type) indicating the type of reuse material 4, a date of purchase of the reuse material 4, a current position of the reuse material 4, and current position registration date and time of the reuse material 4. Examples of the material type information indicating the type of reuse material 4 include a cart, a 6-wheel car truck, a foldable container L-size, a foldable container M-size, and a pallet.

For example, the current position of the reuse material includes GPS coordinates that indicate latitude and longitude.

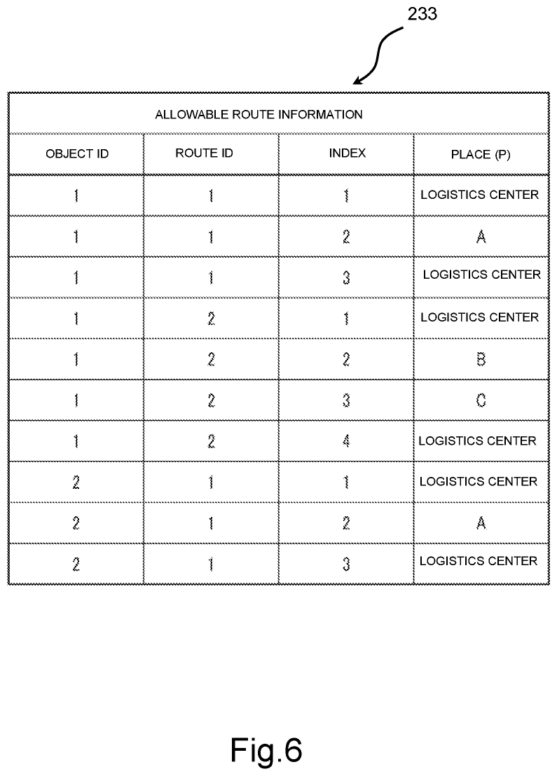

FIG. 6 shows an example of the route information table 233 managed by the reuse material management apparatus 2 according to the embodiment. For example, the auxiliary storage device 2c of the reuse material management apparatus 2 stores the route information table 233. As shown in FIG. 6, the route information table 233 includes a plurality of records each including allowable route information. The allowable route information includes material identification information (Object ID), allowable route identification information (Route ID) indicating an allowable route, an index (Index) set to an allowable position included in the allowable route, and allowable position information (Place (P)) indicating the allowable position included in the allowable route. For example, the allowable position information includes GPS coordinates that indicate latitude and longitude. The processor 2a detects the allowable route assigned to the reuse material 4 on the basis of the route information table 233. Moreover, the processor 2a determines route violation of the reuse material 4 on the basis of the event information table 231 and the route information table 233.

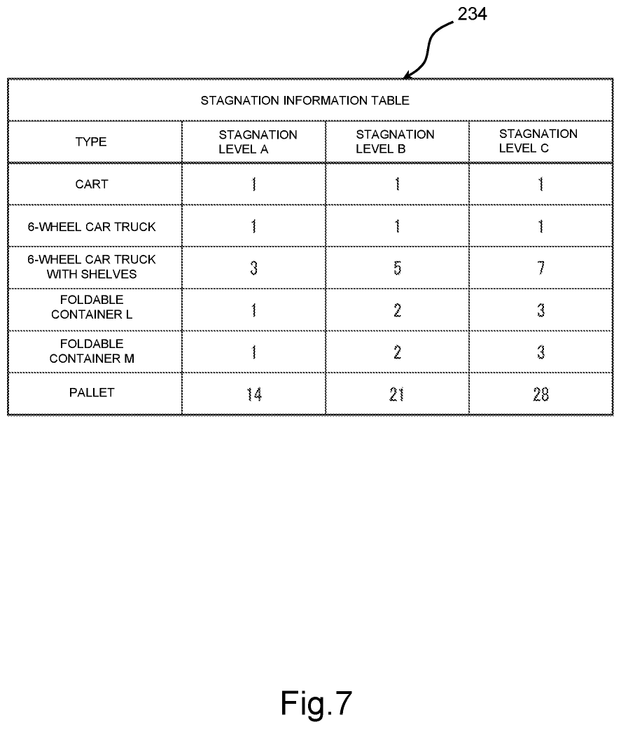

FIG. 7 is a diagram showing an example of the stagnation information table 234 managed by the reuse material management apparatus 2 according to the embodiment.

For example, the auxiliary storage device 2c of the reuse material management apparatus 2 stores the stagnation information table 234. As shown in FIG. 7, the stagnation information table 234 includes a plurality of records each including stagnation information. The stagnation information includes material type information (Type) indicating the type of reuse material 4, the number of vehicles at a stagnation level A, the number of vehicles at a stagnation level B, and the number of vehicles at a stagnation level C. It should be noted that the stagnation means that the reuse material 4 is not moved (used) and remains in the same place.

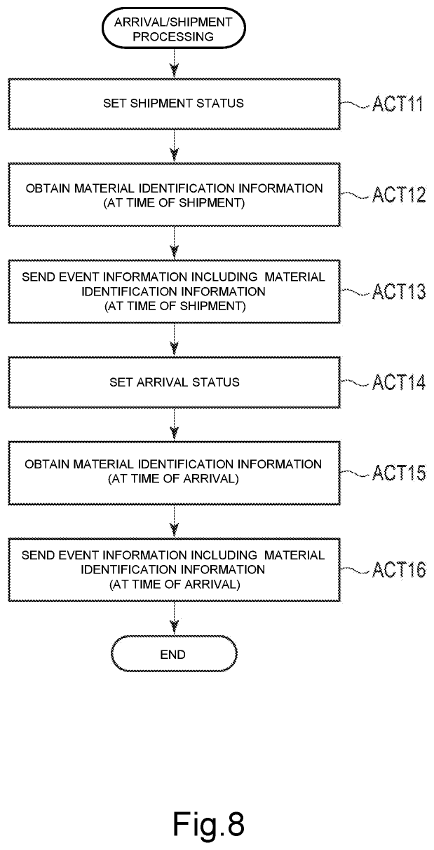

Next, respective processes in the reuse material management system 1 will be described. FIG. 8 shows an example of arrival/shipment processing by the communication terminal apparatus 3 according to the embodiment. For example, at the time of shipment from a factory, the person in charge uses the input device 3e of the communication terminal apparatus 3 to enter the shipment status. In ACT11 of FIG. 8, the processor 3a sets the shipment status by storing the shipment status in the auxiliary storage device 3c. In addition, the person in charge brings the communication terminal apparatus 3 closer to the information storage medium 5 of the reuse material 4 in which the goods to be shipped are loaded or accommodated.

The reader 3g of the communication terminal apparatus 3 brought closer to the information storage medium 5 reads the material identification information from the information storage medium 5. In ACT12, the processor 3a obtains the read material identification information via the reader 3g. In ACT13, the processor 3a generates event information including the material identification information and the like obtained in accordance with reading of the material identification information. The processor 3a controls the communication device 3d to send the generated event information to the reuse material management apparatus 2. The communication device 3d sends the generated event information to the reuse material management apparatus 2.

In a state in which the shipment status has been set, the event information generated by processor 3a includes the read material identification information, date and time information (date and time of shipment) of reading of the material identification information, detection position information indicating a position of reading, and information about the shipment status set as the event type information.

The processor 3a sets the current date and time information received by communication device 3d from the reuse material management apparatus 2 as the date and time information of reading of the material identification information. Moreover, the processor 3a sets information about the current position detected by position information detection device 3h as the detection position information (detection position information about a shipment destination).

The above-mentioned processing is repeated for the reuse material 4 in which the goods to be shipped are loaded or accommodated. After the above-mentioned processing is performed on all the reuse materials 4 to be shipped, the goods loaded or accommodated in the reuse materials 4 are transported.

When the goods loaded or accommodated in the reuse materials 4 arrive at an arrival destination, the person in charge operates the input device 3e of the communication terminal apparatus 3 to enter the arrival status at the arrival destination. In ACT14, the processor 3a sets the arrival status in the auxiliary storage device 3c by storing the arrival status in the auxiliary storage device 3c. In addition, the person in charge brings the communication terminal apparatus 3 closer to the information storage medium 5 of the reuse material 4 in which the goods to arrive are loaded or accommodated.

The reader 3g of the communication terminal apparatus 3 brought closer to the information storage medium 5 reads the material identification information from the information storage medium 5. In ACT15, the processor 3a obtains the read material identification information via the reader 3g. In ACT16, the processor 3a generates event information including the material identification information and the like obtained in accordance with reading of the material identification information. The processor 3a controls the communication device 3d to send the generated event information to the reuse material management apparatus 2. The communication device 3d sends the generated event information to the reuse material management apparatus 2.

In a state in which the arrival status has been set, the event information generated by processor 3a includes of the read material identification information, date and time information (date and time of arrival) of reading of the material identification information, detection position information indicating a position of reading, and information about the arrival status set as the event type information. The processor 3a sets the current date and time information that the communication device 3d receives from the reuse material management apparatus 2 as the date and time information of reading of the material identification information. Moreover, the processor 3a sets the information about the current position detected by the position information detection device 3h as the detection position information (detection position information about the arrival destination).

The above-mentioned processing is repeated for the reuse material 4 in which the goods to arrive are loaded or target. When the above-mentioned processing is performed on all the reuse materials 4 to arrive, the arrival processing is completed.

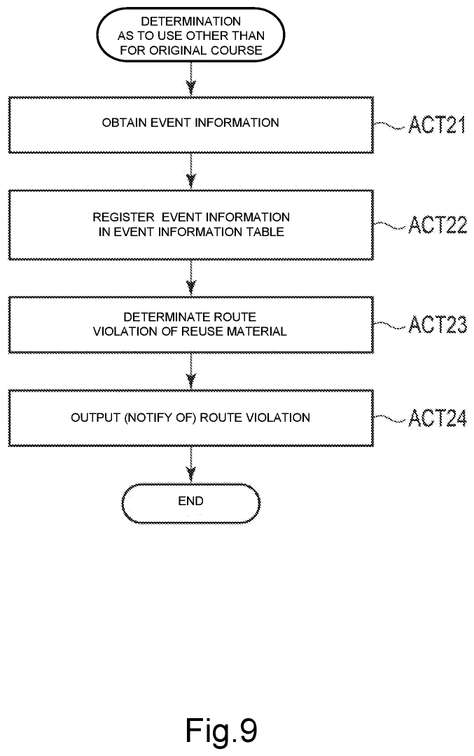

FIG. 9 shows an example of a determination as to the use of the reuse material 4 other than for the original purpose by the reuse material management apparatus 2 according to the embodiment. The communication device 2d of the reuse material management apparatus 2 receives information sent from the communication terminal apparatus 3. For example, the communication device 2d receives the event information sent from the communication terminal apparatus 3 at the time of shipment and at the time of arrival of goods loaded or accommodated in the reuse material 4. For example, the communication device 2d receives the event information sent from the communication terminal apparatus 3 at the time of shipment and arrival. In ACT21 of FIG. 9, the processor 2a obtains the received event information via communication device 2d. The event information includes the information about the date and time information, the information about the arrival status or the shipment status, the information about the detection position information, and the information about the material identification information. In ACT22, the processor 2a registers the acquired event information in the event information table 231. Here, the information about the arrival status or the shipment status of the event information is registered as the event identification information table 231.

In addition, in ACT23, the processor 2a determines the route violation of the reuse material 4 on the basis of the allowable route information included in the route information table 233 and the event information included in the event information table 231. The allowable route information includes the allowable position information indicating the allowable position included in the allowable route for movement set for each reuse material 4. The event information includes the date and time information and the detection position information of the reuse material 4. The processor 2a compares the allowable position information set for each reuse material 4 with the detection position information of each reuse material 4 on the basis of the allowable route information and the event information. The processor 2a determines that the route is correct in a case where the allowable position information and the detection position information are substantially the same, and determines the route violation in a case where they are not substantially the same. It should be noted that the processor 2a determines that the difference is substantially the same in a case where the difference between allowable position information and detection position information is less than a reference value, and the processor 2a determines that the difference is not substantially the same in a case where the difference is equal to or greater than the reference value.

Moreover, the processor 2a may determine the route violation of the reuse material 4 on the basis of the allowable route information included in the route information table 233 and the reuse material management information included in the reuse material management information table 232. The processor 2a periodically updates the reuse material management information table 232 on the basis of event information included in the event identification information table 231. That is, the processor 2a selects the record including the latest date and time information (Event Time) from the records including the same predetermined material identification information (Object ID) included in the event information table 231. In addition, the processor 2a writes the date and time information included in the selected record in the current position registration date and time of the record including the same predetermined material identification information included in the reuse material management information table 232. In addition, the processor 2a writes the detection position information (Place (D)) included in the selected record in the current position of the record including the same predetermined material identification information included in the reuse material management information table 232.

The processor 2a obtains information about the current position of the reuse material 4 on the basis of the reuse material management information table 232. On the basis of the information about the current position of each reuse material 4, the processor 2a may determine the route violation of the reuse material 4 in a state of being deviated from the allowable route for a reference determination time or more. For example, the processor 2a determines the route violation of the reuse material 4 in the state of being deviated from the allowable route for 24 hours or more on the basis of the information about the current position of each reuse material 4. If the reuse material 4 is returned to the allowable route early even if the reuse material 4 is temporarily deviated from the allowable route, then the processor 2a determines that the reuse material 4 is moved on the correct route.

As described above, when the route violation of the reuse material 4 is determined, the processor 2a instructs communication device 2d and the display 2f to output determination result such as route violation in ACT24. The communication device 2d and the display 2f output the determination result such as route violation. For example, the communication device 2d notifies a designated notification destination registered in the auxiliary storage device 2c of warning guidance including the route violation of the reuse material 4. As the designated notification destination, an arbitrary e-mail address of a logistics company that is the owner of the reuse material 4 may be registered, or an arbitrary communication terminal apparatus 3 may be registered. Moreover, the display 2f displays the warning guidance including the route violation of the reuse material 4.

It should be noted that the processor 2a may manage the number of reuse materials 4 in an arrival or shipment position on the basis of the event information registered in the event information table 231. For example, the processor 2a counts up the reuse materials 4 in the arrival position in accordance with arrival, and counts down the reuse materials 4 in the arrival position and counts up the reuse materials 4 in the shipment position in accordance with shipment.

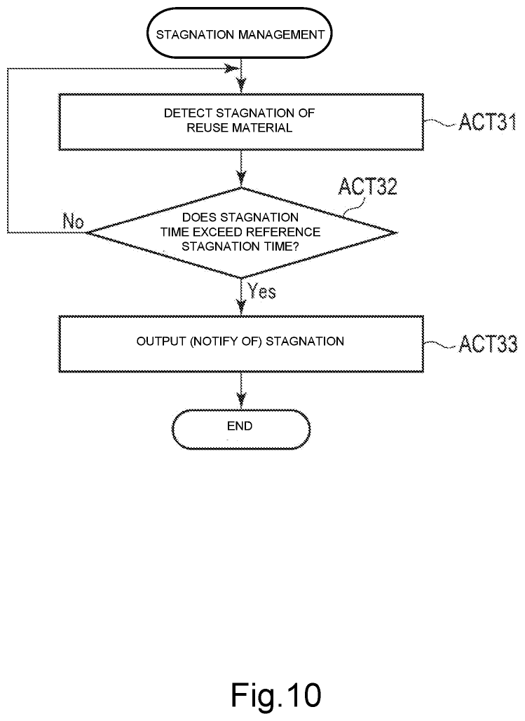

Next, this section describes stagnation control of the reuse material 4 by the reuse material management apparatus 2. FIG. 10 shows an example of the stagnation control of the reuse material by the reuse material management apparatus 2 according to the embodiment. In ACT31, the processor 2a of the reuse material management apparatus 2 detects stagnation of the reuse material 4 on the basis of the event information table 231. For example, the processor 2a detects a stagnation time and a stagnation location of the reuse material 4 on the basis of the date and time information (Event Time), the event type information (Event Type), and the detection position information (Place (D)) of the same material identification information. The processor 2a detects consecutive shipment and arrival on the basis of the date and time information and the event type information and detects a stagnation time on the basis of a difference between the date and time information of the shipment and the date and time information of the arrival. Moreover, if the date and time information of the arrival is not found after the date and time information of the shipment, the processor 2a detects a stagnation time on the basis of a difference between the date and time information of the shipment and the current date and time.

Moreover, the processor 2a classifies each stagnation time into one of the stagnation level A, the stagnation level B, and the stagnation level C. For example, the processor 2a classifies stagnation for a time longer than 48 hours into the stagnation level A, stagnation for a time longer than 24 hours and equal to or shorter than 48 hours into the stagnation level B, and stagnation for a time longer than 12 hours and equal to or shorter than 24 hours into the stagnation level C. Moreover, the processor 2a detects the number of vehicles corresponding to the stagnation level A, the number of vehicles corresponding to the stagnation level B, and the number of vehicles corresponding to the stagnation level C in association with the material type information indicating the type of reuse material 4. The processor 2a registers the detection result as the stagnation information in the stagnation information table 234.

In addition, in ACT32, the processor 2a determines whether or not the stagnation time exceeds a reference stagnation time. In a case where the processor 2a determines that the stagnation time exceeds the reference stagnation time (ACT32, YES), the processing of the processor 2a proceeds to ACT33. In ACT33, the processor 2a instructs the communication device 2d to output the stagnation detection result. The communication device 2d outputs the stagnation detection result to the designated notification destination registered in the auxiliary storage device 2c. The stagnation detection result includes the material identification information, the stagnation time, and the stagnation location of the reuse material 4 that has stagnated. As the designated notification destination, an arbitrary e-mail address of a logistics company that is the owner of the reuse material 4 may be registered, or an arbitrary communication terminal apparatus 3 may be registered.

Moreover, the processor 2a may search for the communication terminal apparatus 3 in the stagnation location and instruct the communication terminal apparatus 3 in the stagnation location to output the stagnation detection result including the request to collect the stagnating reuse material 4. The communication device 3d of each communication terminal apparatus 3 periodically sends terminal identification information and the information about the current position to the reuse material management apparatus 2. The communication device 2d of the reuse material management apparatus 2 receives the terminal identification information and the information about the current position sent from each communication terminal apparatus 3. The processor 2a detects the communication terminal apparatus 3 within a predetermined range including the stagnation location on the basis of the terminal identification information and the information about the current position sent from each communication terminal apparatus 3. Moreover, the communication device 2d of the reuse material management apparatus 2 sends the stagnation detection result to the detected communication terminal apparatus 3. The communication device 3d of the communication terminal apparatus 3 receives the stagnation detection result. The display 3f displays the stagnation detection result. The person in charge carrying the communication terminal apparatus 3 that receives the stagnation detection result can then find and move the relatively near stagnating reuse material 4. It should be noted that the reuse material management apparatus 2 may output guidance depending on the stagnation level.

With the reuse material management apparatus 2 according to the embodiment, it is possible to manage the use status of the reuse material 4 without a heavy burden on the person in charge. For example, the person in charge only needs to bring the communication terminal apparatus 3 close to the information storage medium 5 attached to the reuse material 4 in which goods are loaded or accommodated when the goods arrive and are shipped.

The communication terminal apparatus 3 reads the material identification information from the information storage medium 5 and sends the event information including the material identification information and the like to the reuse material management apparatus 2. For example, the event information includes date and time information, event type information, event type detection position information, and material identification information.

The reuse material management apparatus 2 obtains the event information sent from the communication terminal apparatus 3. Then, the reuse material management apparatus 2 determines the route violation of the reuse material 4 on the basis of the allowable route information and the event information and notifies of the route violation of the reuse material 4. For example, the route violation of the reuse material 4 is notified to an arbitrary e-mail address of a logistics company. Based on this notification, the person in charge can grasp the use of the reuse material 4 other than for the original purpose.

In addition, the reuse material management apparatus 2 determines the route violation of the reuse material 4 in the state of being deviated from the allowable route for the reference determination time or more and notifies of the route violation of the reuse material 4. As a result, severe route violation determinations can be reduced and the frequency of violation notifications can be reduced.

Moreover, the reuse material management apparatus 2 obtains the event information including the arrival status or the shipment status. The reuse material management apparatus 2 manages the arrival status or the shipment status of the reuse material 4 on the basis of the event information. As a result, the use of the reuse material 4 can be managed, and the arrival status or the shipment status can also be managed.

In addition, the reuse material management apparatus 2 may notify of the route violation including the arrival or shipment status. As a result, the person in charge can grasp what kind of status the route violation has occurred in.

In addition, the reuse material management apparatus 2 detects stagnation of the reuse material 4 on the basis of the event information and outputs the stagnation detection result of the reuse material 4. As a result, the person in charge can grasp the stagnation of the reuse material 4. Moreover, the reuse material management apparatus 2 is also capable of sending the stagnation detection result to the communication terminal apparatus 3 in the stagnation location of the reuse material 4. This allows the person in charge to relatively easily take measures such as collecting the stagnating reuse material 4.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A reuse material management apparatus that receives information about a reuse material that is moved with goods loaded or accommodated in the reuse material, from a communication terminal apparatus, and manages a reuse material, comprising:
a communication device that communicates with the communication terminal apparatus;
a storage device that stores allowable route information of the reuse material, the allowable route information including allowable position information indicating an allowable position included in an allowable route for movement set with respect to the reuse material; and
a processor that
obtains event information including detection position information indicating a position of the reuse material from the communication terminal apparatus via the communication device,
determines, on the basis of the allowable position information included in the allowable route information and detection position information of the reuse material included in the obtained event information, route violation of a state of deviated from the allowable route of the reuse material, and
outputs a determination result of the route violation of the reuse material via the communication device.

2. The reuse material management apparatus according to claim 1, wherein
the event information includes the detection position information together with the material identification information for identification of the reuse material,
the allowable route information includes the allowable position information together with the material identification information, and
the processor determines the route violation of the reuse material on the basis of the event information and the allowable route information including the same the material identification information.

3. The reuse material management apparatus according to claim 1, wherein
the event information includes date and time information, and
the processor determines, on the basis of the date and time information included in the event information, the route violation of the reuse material in a state of being deviated from the allowable route for a predetermined reference determination time or more.

4. The reuse material management apparatus according to claim 1, wherein
the event information includes an arrival status or a shipment status as a type of event of the reuse material, and
the processor outputs a determination result of the route violation including the arrival status or the shipment status via the communication device.

5. The reuse material management apparatus according to claim 3, wherein
the processor detects, on the basis of the event information, stagnation of the reuse material and outputs a detection result of the stagnation of the reuse material.

6. A reuse material management method for a reuse material management apparatus that receives information about a reuse material that is moved with goods loaded or accommodated in the reuse material, from a communication terminal apparatus, and manages a reuse material, comprising:
storing allowable route information of the reuse material, the allowable route information including allowable position information indicating an allowable position included in an allowable route for movement set with respect to the reuse material;
obtaining event information including detection position information indicating a position of the reuse material from the communication terminal apparatus via a communication device;
determining, on the basis of the allowable position information included in the allowable route information and detection position information of the reuse material included in the obtained event information route violation of a state of being deviated from the allowable route of the reuse material; and
outputting a determination result of the route violation of the reuse material via the communication device.

7. A reuse material management system, comprising:
a communication terminal apparatus; and
a reuse material management apparatus that receives information about a reuse material that is moved with goods loaded or accommodated in the reuse material, from a communication terminal apparatus, and manages a reuse material, wherein
the communication terminal apparatus includes
a first communication device that communicates with the reuse material management apparatus, and
a first processor that
obtains event information including detection position information indicating a position of the reuse material from the reuse material, and
sends the obtained event information of the reuse material via the first communication device, and
the reuse material management apparatus includes
a second communication device that communicates with the communication terminal apparatus,
a storage device that stores allowable route information of the reuse material, the allowable route information including allowable position information indicating an allowable position included in an allowable route for movement set with respect to the reuse material, and
a second processor that
obtains event information including detection position information indicating a position of the reuse material from the communication terminal apparatus via the second communication device,
determines, on the basis of the allowable position information included in the allowable route information and detection position information of the reuse material included in the obtained event information, route violation of a state of being deviated from the allowable route of the reuse material, and
outputs a determination result of the route violation of the reuse material via the second communication device.

8. The reuse material management system according to claim 7, wherein
the communication terminal apparatus further includes a position information detection device that detects a current position as detection position information corresponding to actual position information of the reuse material, and
the first processor sends the event information including the detection position information detected by the position information detection device via the first communication device.

9. The reuse material management system according to claim 8, wherein
the communication terminal apparatus further includes a reader that reads material identification information for identifying the reuse material from the reuse material, and
the first processor
obtains the material identification information via the reader, and
sends the event information including the material identification information for identification of the reuse material and the detection position information via the first communication device.

10. The reuse material management system according to claim 9, wherein
the communication terminal apparatus further includes an input device that receives an entry of an arrival status or a shipment status as a type of event of the reuse material, and
the processor sends the event information including the arrival status or the shipment status via the first communication device.
